(19) United States
(12) Patent Application Publication
(10) Pub. No.: US 2026/0003238 A1
(43) Pub. Date: Jan. 1, 2026

(54) ELECTRONIC DEVICE

(71) Applicant: InnoLux Corporation, Miao-Li County (TW)

(72) Inventors: Cheng-Yu YANG, Miao-Li County (TW); Ming-Jou TAI, Miao-Li County (TW); Chih-Hao CHANG, Miao-Li County (TW); Chia-Hao TSAI, Miao-Li County (TW)

(73) Assignee: InnoLux Corporation, Miao-Li County (TW)

(21) Appl. No.: 19/216,759

(22) Filed: May 23, 2025

(30) Foreign Application Priority Data
Jun. 26, 2024 (CN) 202410833601.4

(51) Int. Cl. G02F 1/1362; G02F 1/1343; G02F 1/1368

(52) U.S. Cl. CPC G02F 1/136286; G02F 1/134309; G02F 1/1368; G02F 2201/123

(57) ABSTRACT

An electronic device includes a substrate, a first active layer, a second active layer, an insulating layer and a metal line. The first active layer is disposed on the substrate and includes a first end. The second active layer is disposed on the substrate and includes a second end, wherein the second end is adjacent to the first end. The insulating layer is disposed on the first active layer and the second active layer. The metal line is disposed on the insulating layer. In a cross-sectional view of the electronic device, the insulating layer includes a first opening, and a portion of the metal line is disposed in the first opening and overlapped with the first end, and in a top view of the electronic device, the first end has an edge, a portion of the edge is arc-shaped and located between the first opening and the second end.

### BACKGROUND OF THE DISCLOSURE

### 1. Field Of The Disclosure

The present disclosure relates to an electronic device, and more particularly to a display device with high resolution.

### 2. Description Of The Prior Art

As the requirements for the resolution of display devices increase, the layout space of a pixel in the display device may thereby decrease. In such condition, some processes of the display device may be affected by the reduction in the layout space of the pixels, thereby affecting the process yield of the display device. Therefore, to solve the above-mentioned problems is still an important issue in the present field.

### SUMMARY OF THE DISCLOSURE

The present disclosure aims at providing an electronic device with high resolution, wherein the mask used in the manufacturing process of the electronic device may have a specific design to reduce the possibility that some of the manufacturing processes are affected by the reduction of the layout space of the pixels.

An electronic device is provided by the present disclosure. The electronic device includes a substrate, a first active layer, a second active layer, an insulating layer and a metal line. The first active layer is disposed on the substrate and includes a first end. The second active layer is disposed on the substrate and includes a second end, wherein the second end is adjacent to the first end. The insulating layer is disposed on the first active layer and the second active layer. The metal line is disposed on the insulating layer. In a cross-sectional view of the electronic device, the insulating layer includes a first opening, and a portion of the metal line is disposed in the first opening and overlapped with the first end, and in a top view of the electronic device, the first end has an edge, a portion of the edge is arc-shaped and located between the first opening and the second end.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a top view of an electronic device according to a first embodiment of the present disclosure.

FIG. 2 schematically illustrates a cross-sectional view of the electronic device according to the first embodiment of the present disclosure.

FIG. 3 schematically illustrates a partial enlarged top view of the electronic device according to the first embodiment of the present disclosure.

FIG. 4 to FIG. 8 schematically illustrate partial enlarged top views of electronic devices according to variant embodiments of the first embodiment of the present disclosure.

FIG. 9 schematically illustrates a top view of an electronic device according to a second embodiment of the present disclosure.

FIG. 10 schematically illustrates a cross-sectional view of the electronic device according to the second embodiment of the present disclosure.

FIG. 11 schematically illustrates a top view of an electronic device according to a third embodiment of the present disclosure.

FIG. 12 schematically illustrates a cross-sectional view of the electronic device according to the third embodiment of the present disclosure.

FIG. 13 schematically illustrates a cross-sectional view of the electronic device according to the third embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, electronic equipment manufacturers may refer to an element by different names. This document does not intend to distinguish between elements that differ in name but not function.

In the following description and in the claims, the terms “include”, “comprise” and “have” are used in an open-ended fashion, and thus should be interpreted to mean “include, but not limited to . . . ”.

It will be understood that when an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented. When an element or a layer is referred to as being “electrically connected” to another element or layer, it can be a direct electrical connection or an indirect electrical connection. The electrical connection or coupling described in the present disclosure may refer to a direct connection or an indirect connection. In the case of a direct connection, the ends of the elements on two circuits are directly connected or connected to each other by a conductor segment. In the case of an indirect connection, switches, diodes, capacitors, inductors, resistors, other suitable elements or combinations of the above elements may be included between the ends of the elements on two circuits, but not limited thereto.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

According to the present disclosure, the thickness, length and width may be measured through optical microscope, and the thickness or width may be measured through the cross-sectional view in the electron microscope, but not limited thereto.

In addition, any two values or directions used for comparison may have certain errors. In addition, the terms “equal to”, “equal”, “the same”, “approximately” or “substantially” are generally interpreted as being within ±10%, ±5%, ±3%, ±2%, ±1%, or ±0.5% of the given value.

In addition, the terms “the given range is from a first value to a second value” or “the given range is located between a first value and a second value” represents that the given range includes the first value, the second value and other values there between.

If a first direction is said to be perpendicular to a second direction, the included angle between the first direction and the second direction may be located between 80 to 100 degrees. If a first direction is said to be parallel to a second direction, the included angle between the first direction and the second direction may be located between 0 to 10 degrees.

Unless it is additionally defined, all terms (including technical and scientific terms) used herein have the same meaning as commonly understood by those ordinary skilled in the art. It can be understood that these terms that are defined in commonly used dictionaries should be interpreted as having meanings consistent with the relevant art and the background or content of the present disclosure, and should not be interpreted in an idealized or overly formal manner, unless it is specifically defined in the embodiments of the present disclosure.

It should be noted that the technical features in different embodiments described in the following can be replaced, recombined, or mixed with one another to constitute another embodiment without departing from the spirit of the present disclosure.

The electronic device of the present disclosure may include a display device, a sensing device, a back-light device, an antenna device, a tiled device, a virtual reality product or other suitable electronic devices, but not limited thereto. The electronic device of the present disclosure may be a foldable electronic device, a flexible electronic device or a stretchable electronic device. The display device may include a non-self-emissive display device or a self-emissive display device. The non-self-emissive display device for example includes a liquid crystal display device, but not limited thereto. The self-emissive display device for example includes a light emitting diode display device, but not limited thereto. The display device may for example be applied to laptops, common displays, tiled displays, vehicle displays, touch displays, televisions, monitors, smart phones, tablets, light source modules, lighting devices or electronic devices applied to the products mentioned above, but not limited thereto. The sensing device may include a biosensor, a touch sensor, a fingerprint sensor, other suitable sensors or combinations of the above-mentioned sensors. The antenna device may for example include a liquid crystal antenna device, but not limited thereto. The tiled device may for example include a tiled display device or a tiled antenna device, but not limited thereto. The outline of the electronic device may be a rectangle, a circle, a polygon, a shape with curved edge or other suitable shapes. The electronic device may include electronic units, wherein the electronic units may include passive elements or active elements, such as capacitor, resistor, inductor, diode, transistor, sensors, and the like. The diode may include a light emitting diode or a photo diode. The light emitting diode may for example include an organic light emitting diode (OLED) or an inorganic light emitting diode. The inorganic light emitting diode may for example include a mini light emitting diode (mini LED), a micro light emitting diode (micro LED) or a quantum dot light emitting diode (QLED), but not limited thereto. The electronic device may include peripheral systems such as driving systems, controlling systems, light source systems to support display devices, antenna devices, wearable devices (such as augmented reality devices or virtual reality devices), vehicle devices (such as windshield of car) or tiled devices. The display device is taken as an example of the electronic device for describing the contents of the present disclosure in the following, but the present disclosure is not limited thereto. The electronic device of the present disclosure may be combinations of the above-mentioned devices, such as the combination of display device and other devices, but not limited thereto.

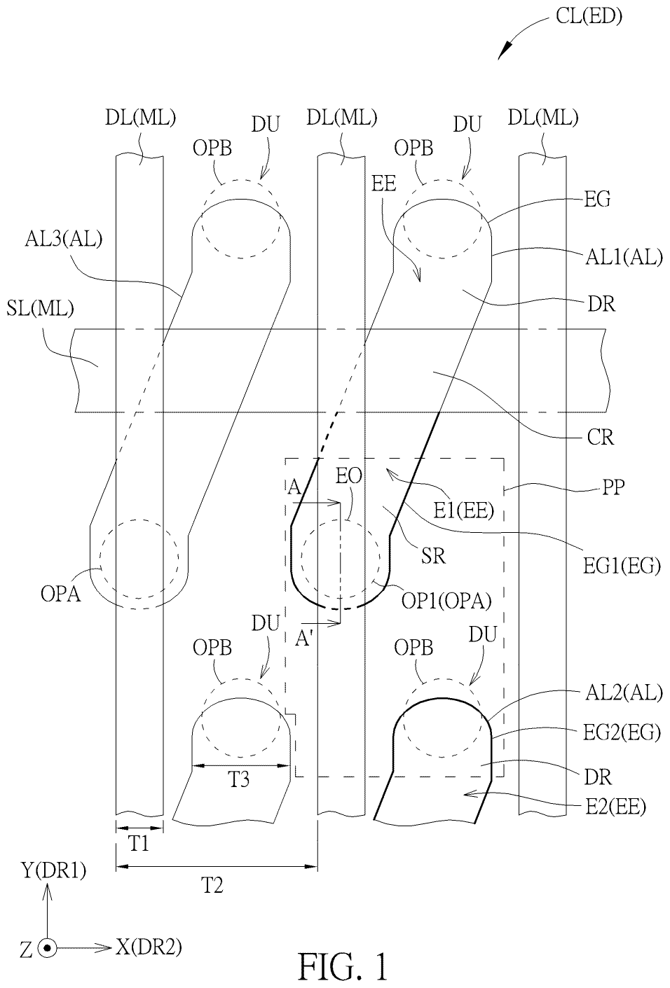

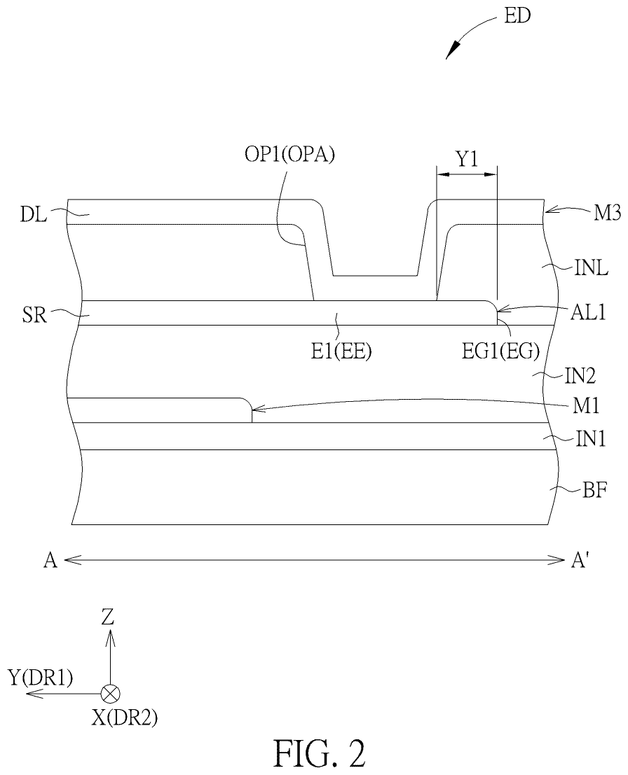

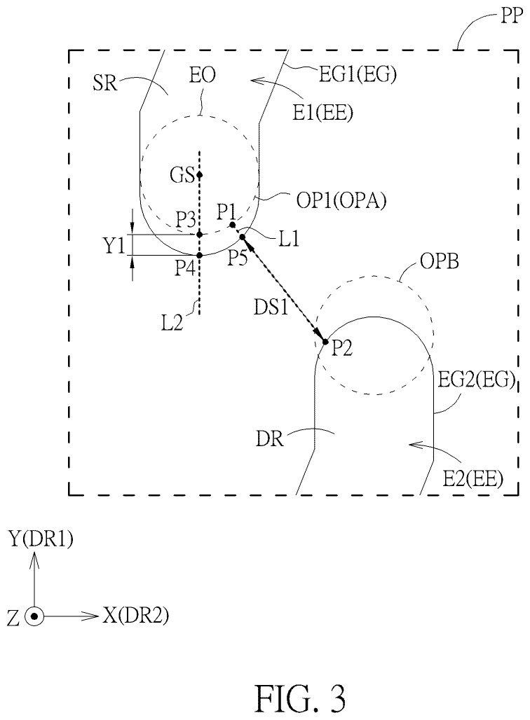

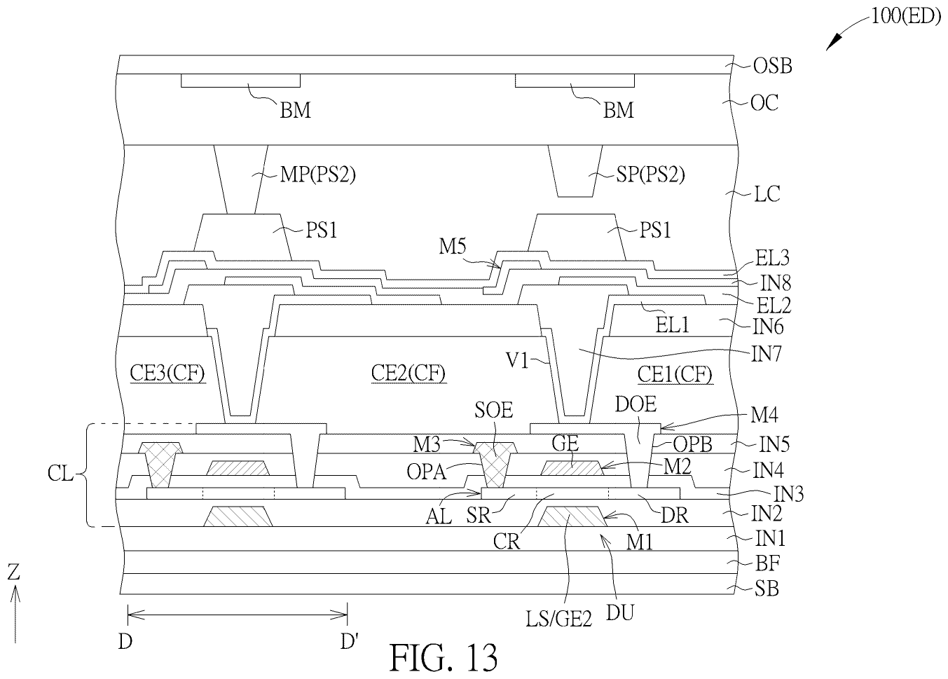

Referring to FIG. 1 to FIG. 3 and FIG. 13, FIG. 1 schematically illustrates a top view of an electronic device according to a first embodiment of the present disclosure, FIG. 2 schematically illustrates a cross-sectional view of the electronic device according to the first embodiment of the present disclosure, FIG. 3 schematically illustrates a partial enlarged top view of the electronic device according to the first embodiment of the present disclosure, and FIG. 13 schematically illustrates a cross-sectional view of the electronic device according to the third embodiment of the present disclosure. In order to simplify the figures, FIG. 1 to FIG. 3 just show some of the elements or layers of the electronic device ED. It should be noted that the structure of the third embodiment shown in FIG. 13 may be the structure derived from the electronic device ED of the first embodiment and may be applied to the embodiments of the present disclosure. That is, the cross-sectional structure of the electronic device ED of the first embodiment shown in FIG. 1 may refer to the structure shown in FIG. 13. The electronic device ED of the present embodiment may include a display device 100 (labeled in FIG. 13) for displaying images or pictures. The display device 100 may be a high resolution display device, such as a virtual reality display device, but not limited thereto. In some embodiments, the electronic device ED may be a combination of the display device 100 and other suitable electronic devices. The detail of the structure of the electronic device ED (or the display device 100) of the present embodiment may for example refer to the structure shown in FIG. 13. As shown in FIG. 13, the electronic device ED may include a substrate SB, a circuit layer CL, a light converting layer CF and a display medium layer LC. The circuit layer CL may be disposed on the substrate SB, the light converting layer CF may be disposed on the circuit layer CL, and the display medium layer LC may be disposed on the light converting layer CF. The structures of the elements and layers of the electronic device ED will be detailed in the following.

The substrate SB may be used to support the elements and layers disposed thereon. The substrate SB may include a rigid material or a flexible material. The rigid material for example includes glass, quartz, sapphire, ceramic, other suitable materials or combinations of the above-mentioned materials. The flexible material for example include polyimide (PI), polycarbonate (PC), polyethylene terephthalate (PET), other suitable materials or combinations of the above-mentioned materials. It should be noted that the substrate SB may include a multi-layer structure in some embodiments, which is not limited to what is shown in FIG. 13.

The circuit layer CL may include various kinds of wires, circuits or electronic units that can be applied to the electronic device ED. The electronic unit may include any suitable active elements and/or passive elements. The circuit layer CL may include any suitable structure formed by stacking conductive layer(s) and insulating layer(s), wherein the conductive layer(s) may be used for forming the wires, the circuits or the electronic units mentioned above, but not limited thereto. FIG. 1 for example shows a portion of the structure of the circuit layer CL of the electronic device ED. As shown in FIG. 1, the circuit layer CL may include a plurality of metal lines ML disposed on the substrate SB. The metal lines ML may include scan lines SL and data lines DL. In other words, the circuit layer CL includes a plurality of scan lines SL (FIG. 1 just shows one scan line) and a plurality of data lines DL disposed on the substrate SB. The data lines DL may extend along a first direction DR1, and the scan lines SL may extend along a second direction DR2, wherein the first direction DR1 is not parallel to the second direction DR2. For example, the first direction DR1 may be the direction Y, and the second direction DR2 may be the direction X, that is, the first direction DR1 may be perpendicular to the second direction DR2, but not limited thereto. In some embodiments, the first direction DR1 may not be perpendicular to the second direction DR2. In some embodiments, the first direction DR1 may be an inclined direction not parallel to the direction X and the direction Y (for example, the included angle between the inclined direction and the direction X and the included angle between the inclined direction and the direction Y are not 90 degrees). That is, the data lines DL may extend along the inclined direction. It should be noted that although the scan lines SL and the data lines DL shown in FIG. 1 have linear patterns, it is not limited in the present embodiment. In some embodiments, the data lines DL may include any suitable pattern, such as a zigzag pattern or an irregular pattern, but not limited thereto.

In such condition, “the data lines DL extend along the first direction DR1” mentioned above may represent that even if the pattern of the data line DL is not completely parallel to the first direction DR1, the data line DL may still tends to extend along the first direction DR1. Similarly, “the scan lines SL extend along the second direction DR2” mentioned above may represent that the pattern of the scan line SL tends to extend along the second direction DR2.

In the present embodiment, the circuit layer CL may further include driving units DU. The driving unit DU may for example include a thin film transistor (TFT) element, but not limited thereto. As shown in FIG. 13, the driving unit DU may include an active layer AL, a gate electrode GE, a source electrode SOE and a drain electrode DOE. Specifically, the circuit layer CL may include an active layer AL, a conductive layer M2, a conductive layer M3 and a conductive layer M4, wherein the active layer AL may include a channel region CR, a source region SR and a drain region DR, and the conductive layer M2 may form the gate electrode GE of the driving unit DU. The channel region CR may be defined as the portion of the active layer AL overlapped with the gate electrode GE. The source region SR and the drain region DR may respectively be defined as the portions of the active layer AL at two sides of the channel region CR. The conductive layer M3 may form the source electrode SOE electrically connected to the source region SR. The conductive layer M4 may form the drain electrode DOE electrically connected to the drain region DR. The active layer AL may include semiconductor materials, wherein the semiconductor materials may include indium gallium zinc oxide (IGZO), amorphous indium gallium zinc tin oxide (a-IGZO), indium zinc oxide (IZO), amorphous indium-zinc-tin oxide (a-IZTO), zinc tin oxide (AZTO), indium gallium zinc oxide (IGO) or indium gallium zinc tin oxide (IGZTO), but not limited thereto. The conductive layer M2 and the conductive layer M3 may include any suitable conductive material, such as metal materials, but not limited thereto. The conductive layer M4 may include any suitable conductive material, such as metal materials or transparent conductive materials, but not limited thereto. The transparent conductive materials for example includes indium tin oxide (ITO), indium zinc oxide (IZO), indium tin zinc oxide (ITZO), other suitable materials or combinations of the above-mentioned materials, but not limited thereto. The circuit layer CL may further include an insulating layer IN3 disposed between the active layer AL and the conductive layer M2, an insulating layer IN4 disposed between the conductive layer M2 and the conductive layer M3 and an insulating layer IN5 disposed between the conductive layer M3 and the conductive layer M4. The insulating layer IN3, the insulating layer IN4 and the insulating layer IN5 may include any suitable insulating material, such as organic insulating materials or inorganic insulating materials. For example, the insulating layer IN3, the insulating layer IN4 and the insulating layer IN5 may include silicon nitride (SiNₓ), silicon oxide (SiOₓ), silicon oxynitride (SiNₓO_{y}), polyimide (PI), polyester, other suitable materials or combinations of the above-mentioned materials. The materials of the insulating layers mentioned in the following may refer to the materials described herein, and will not be redundantly described. The insulating layer IN3 may be the gate insulating layer disposed between the active layer AL and the gate electrode GE. It should be noted that although the driving unit DU shown in FIG. 13 includes a top gate thin film transistor, it is not limited in the present disclosure. In other embodiments, the driving unit DU may include a bottom gate thin film transistor, a dual gate thin film transistor, a multi-gate thin film transistor, a dual-channel thin film transistor or a thin film transistor of other suitable types. In some embodiments, the circuit layer CL may further include a conductive layer M1 disposed between the conductive layer M2 and the substrate SB. In some embodiments, the conductive layer M1 may form a light shielding layer LS, wherein the light shielding layer LS may be disposed corresponding to the active layer AL (or at least corresponding to the channel region CR of the active layer AL). In some embodiments, the conductive layer M1 may serve as another gate electrode GE2 of the driving unit DU, that is, the driving unit DU may include a dual gate thin film transistor in this case. The conductive layer M1 may include any suitable conductive material, such as metal materials, but not limited thereto. In some embodiments, the circuit layer CL may further include an insulating layer IN2 disposed between the conductive layer M1 and the active layer AL.

It should be noted that the structure of the circuit layer CL shown in FIG. 13 is exemplary, and it is not limited in the present embodiment. In some embodiments, the electronic device ED may further include a buffer layer BF disposed between the substrate SB and the circuit layer CL and an insulating layer IN1 disposed between the buffer layer BF and the conductive layer M1, but not limited thereto.

As shown in FIG. 13, the electronic device ED may further include a light converting layer CF disposed on the circuit layer CL. The light converting layer CF may be directly disposed on the circuit layer CL, but not limited thereto. In such condition, the manufacturing method of the electronic device ED may include a color filter on array (COA) process. The light converting layer CF may include any suitable element or layer that can change the wavelength or color of the light passing through the light converting layer CF, such as color filter, but not limited thereto. In the present embodiment, the light converting layer CF may include a plurality of light converting elements, wherein these light converting elements may allow lights of different wavelengths or colors to pass through. For example, the light converting layer CF may include a first light converting element CE1, a second light converting element CE2 and a third light converting element CE3, wherein these light converting elements may respectively allow green light, red light and blue light to pass through, which may be mixed into a white light, but not limited thereto. In some embodiments, the electronic device ED may further include an insulating layer IN6 disposed on the light converting layer CF, wherein the insulating layer IN6 may serve as a planarization layer to facilitate disposition of other elements or layers on the insulating layer IN6.

In the present embodiment, as shown in FIG. 13, the electronic device ED may further include an electrode EL1, an insulating layer IN7 disposed on the electrode EL1, an electrode EL2 disposed on the insulating layer IN7, an insulating layer IN8 disposed on the electrode EL2, a conductive layer M5 disposed on the insulating layer IN8 and an electrode EL3 disposed on the conductive layer M5. The electrode EL1 may serve as the pixel electrode, wherein the electrode EL1 may extend into a via V1 and be electrically connected to the conductive layer M4, thereby being electrically connected to the driving unit DU (or the drain electrode DOE of the driving unit DU). The via V1 may be formed by removing a portion of the light converting layer CF and a portion of the insulating layer IN6. The insulating layer IN7 may be filled into the via V1 and cover the electrode EL1. The insulating layer IN7 may serve as a planarization layer to facilitate the disposition of other layers (such as the electrode EL2) on the insulating layer IN7. The electrode EL2 may contact the electrode EL1, thereby being electrically connected to the electrode EL1. The electrode EL1, the electrode EL2 and the electrode EL3 may include any suitable conductive material, such as transparent conductive materials and metal materials, but not limited thereto. The insulating layer IN6, the insulating layer IN7 and the insulating layer IN8 may include any suitable organic insulating material or inorganic insulating material. The conductive layer M5 may include any suitable conductive material, such as metal materials, but not limited thereto. In some embodiments, the conductive layer M5 may include any suitable metal material with low refractive index to reduce the light reflected by metal wires in the electronic device ED being observed by the user or reduce the problem of color mixing between adjacent light converting elements. In some embodiments, the conductive layer M5 may be disposed on the electrode EL3. The conductive layer M5 may for example include molybdenum (Mo), chromium (Cr), tungsten (W), cobalt (Co), nickel (Ni), alloys of the metals mentioned above or oxides of the metals mentioned above, but not limited thereto. In some embodiments, the conductive layer M5 may be replaced with a non-conductive material. In other words, the conductive layer M5 may for example be replaced with black photoresist, black printing ink, black resin, organic resin or glass paste, but not limited thereto.

In the present embodiment, as shown in FIG. 13, the electronic device ED may further include a display medium layer LC located between the substrate SB and an opposite substrate OSB. For example, the display medium layer LC may be located between the electrode EL3 and the protecting layer OC. The display medium layer LC of the present embodiment for example includes liquid crystal material, but not limited thereto. In other words, the electronic device ED of the present embodiment may include a liquid crystal display device. In other embodiments, the electronic device ED may include a display device of other types, such as a light emitting diode display device, and the display medium layer LC may include light emitting diode elements, but not limited thereto.

In the present embodiment, as shown in FIG. 13, the electronic device ED may further include a plurality of spacers PS1 and a plurality of spacers PS2. The spacers PS1 and the spacers PS2 may include any suitable photoresist material. The spacers PS1 may be disposed on the electrode EL3, but not limited thereto. In the top view of the electronic device ED, the spacers PS1 may cover the channel region CR of the active layer AL, but not limited thereto. In addition, in the top view of the electronic device ED, the spacers (such as the spacers PS1 and the spacers PS2) may overlap the conductive layer M1. Specifically, the orthographic projection of the spacers PS1 (or the spacers PS2) on the substrate SB may completely fall within the orthographic projection of the conductive layer M1 on the substrate SB. The spacers PS2 may be disposed corresponding to the spacers PS1. In other words, each spacer PS2 may correspond to one of the spacers PS1. Specifically, the electronic device ED may further include an opposite substrate OSB, and the plurality of spacers PS2 may be disposed on the opposite substrate OSB. In detail, a light shielding layer BM may be disposed on the opposite substrate OSB at first, wherein the light shielding layer BM may be disposed at the positions corresponding to the spacers PS1 and/or the spacers PS2, but not limited thereto. After that, the protecting layer OC may be disposed on the opposite substrate OSB to cover the light shielding layer BM, and the plurality of spacers PS2 may be disposed on the protecting layer OC. After that, the substrate SB and the opposite substrate OSB may be bonded to each other, such that the plurality of spacers PS1 respectively correspond to the plurality of spacers PS2. In the present embodiment, the spacers PS2 may include a main spacer MP and a sub spacer SP. The main spacer MP is one of the spacers PS2 with a greater size, and the sub spacer SP is one of the spacers PS2 with a smaller size. That is, the size of the main spacer MP is greater than the size of the sub spacer SP. “The size of the spacer” mentioned above may for example be the height, thickness or area of the spacer, but not limited thereto. For example, in the normal direction of the electronic device ED (that is, the direction Z), the height or thickness of the main spacer MP may be greater than the height or thickness of the sub spacer SP, or in the top view of the electronic device ED, the area of a side of the main spacer MP adjacent to the opposite substrate OSB may be greater than the area of a side of the sub spacer SP adjacent to the opposite substrate OSB. The main spacer MP may correspond to a portion of the spacers PS1, and the sub spacer SP may correspond to another portion of the spacers PS1. The main spacer MP may contact the spacer PS1 to which the main spacer MP corresponds, and a gap may be included between the sub spacer SP and the spacer PS1 to which the sub spacer SP corresponds, or in other words, the sub spacer SP may not contact the spacer PS1 to which the sub spacer SP corresponds. The material of the opposite substrate OSB may refer to the material of the substrate SB mentioned above. The light shielding layer BM may include any suitable light shielding material. For example, the light shielding layer BM may include black photoresist, black printing ink, black resin, organic resin or glass paste. The structure of the light shielding layer BM may for example be a black matrix, but not limited thereto. In the top view of the electronic device ED, the light shielding layer BM may overlap the channel region CR of the active layer AL, thereby shielding the channel region CR in the top view. In addition, although FIG. 13 shows the structure that the width of the light shielding layer BM is greater than the width of the spacer PS1 and/or the spacer PS2, it is not limited in the present embodiment. In some embodiments, the width of the light shielding layer BM may be less than the width of the spacer PS1 and/or the spacer PS2. In some embodiments, the light shielding layer BM may be disposed on the substrate SB (or disposed at a side of the substrate SB) instead of being disposed on the opposite substrate OSB. The material of the spacer PS1 may be the same as or different from the material of the spacer PS2. The protecting layer OC may include any element or layer that can protect the electronic device ED.

It should be noted that the structure of the electronic device ED of the present embodiment is not limited to what is shown in FIG. 13. In some embodiments, the electronic device ED may further include other suitable elements and/or layers.

Return to FIG. 1, according to the present embodiment, the circuit layer CL may include the plurality of driving units DU, wherein each driving unit DU may be electrically connected to a pixel electrode (not shown in FIG. 1, the electrode EL1 shown in FIG. 13). In such condition, the circuit layer CL may include a plurality of active layers AL disposed on the substrate SB. In the present embodiment, the plurality of active layers AL in the circuit layer CL may be arranged in an array, but not limited thereto. For example, as shown in FIG. 1, the plurality of active layers AL may include a first active layer AL1, a second active layer AL2 and a third active layer AL3, wherein the first active layer AL1 and the second active layer AL2 may be arranged along the direction Y, and the first active layer AL1 and the third active layer AL3 may be arranged along the direction X, but not limited thereto. The materials of different active layers AL may be the same or different. For example, the material of the first active layer AL1 may be the same as or different from the material of the second active layer AL2. The data line DL may be formed of the conductive layer M3 (as shown in FIG. 2), wherein a portion of the data line DL may be electrically connected to the source region SR of the active layer AL of the driving unit DU, thereby forming the source electrode SOE electrically connected to the source region SR. For example, in FIG. 1, a data line DL may be electrically connected to the source region SR of the first active layer AL1 through an opening OPA, and another data line DL may be electrically connected to the source region SR of the third active layer AL3 through another opening OPA. In the top view direction of the electronic device ED (that is, a direction parallel to the direction Z), the opening OPA may at least partially overlap the source region SR. In addition, in the present embodiment, a data line DL may be electrically connected to a plurality of active layers AL arranged along the direction Y. For example, a data line DL may be electrically connected to the first active layer AL1 through an opening OPA, and although it is not shown in FIG. 1, the data line DL may be electrically connected to the second active layer AL2 through another opening OPA. As shown in FIG. 13, the insulating layer IN4 and/or the insulating layer IN3 may surround the opening OPA, and the opening OPA may be formed by removing a portion of the insulating layer IN4 and a portion of the insulating layer IN3, but not limited thereto. In such condition, the opening OPA may expose at least a portion of the active layer AL. In some embodiments, the insulating layer IN3 shown in FIG. 13 may be a patterned layer and disposed only corresponding to the gate electrode GE. In such condition, the opening OPA may be formed by removing a portion of the insulating layer IN4. The scan line SL may be formed of the conductive layer M2. Specifically, a portion of the scan line SL overlapped with the active layer AL may serve as the gate electrode GE. That is, the gate electrode GE may be electrically connected to the scan line SL. In other words, a portion of the active layer AL corresponding to the scan line SL may be defined as the channel region CR, and the portions of the active layer AL located at two sides of the channel region

CR may respectively be defined as the source region SR and the drain region DR. In addition, as shown in FIG. 13, the conductive layer M4 may be electrically connected to the drain region DR of the active layer AL through an opening OPB. In such condition, the opening OPB may at least partially overlap the drain region DR in the top view of the electronic device ED. FIG. 1 shows the opening OPB, but not show the conductive layer M4. It should be noted that FIG. 1 just exemplarily shows the structure including the opening OPA and the opening OPB, but the positions of the opening OPA and the opening OPB are not limited to what is shown in FIG. 1. The detail of the position design of the opening OPA and the opening OPB may refer to FIG. 3 and the description in the following.

As mentioned above, the electronic device ED may include the display device 100 with high resolution. In the present disclosure, “the display device 100 with high resolution” may be defined through the following way. As shown in FIG. 1, in the top view of the electronic device ED (or observe the electronic device ED in the direction Z), the data line DL may have a width T1, a spacing T2 may be included between two adjacent data lines DL, and the active layer AL may have a width T3. The width T1 may be defined as the maximum width of the data line DL measured in a direction (that is, the second direction DR2) perpendicular to the extending direction (that is, the first direction DR1) of the data line DL. In such condition, the spacing T2 may be defined as the maximum distance between the same sides (for example, the left sides in FIG. 1, but not limited thereto) of two adjacent data lines DL in the second direction DR2, and the width T3 of the active layer AL may be defined as the maximum width of the active layer AL in the second direction DR2, but not limited thereto. In other words, the width T1, the spacing T2 and the width T3 may be defined in the same direction (that is, the direction perpendicular to the extending direction of the data line DL). In the present embodiment, the electronic device ED may include a plurality of sub-pixels, wherein the region of a sub-pixel may be defined as the region enclosed by two adjacent scan lines SL crossing two adjacent data lines DL. A sub-pixel may for example include a light converting element (that is, one of the first light converting element CE1, the second light converting element CE2 and the third light converting element CE3 shown in FIG. 13) and the driving unit(s) DU (may be one or more than one) used for driving the portion of the display medium layer LC to which the light converting element corresponds. In such condition, the spacing T2 between two adjacent data lines DL mentioned above may also be regarded as the width of a sub-pixel in the direction X. According to the present disclosure, a ratio of the width T1 to the spacing T2 may range from 0.01 to 0.125 (that is, 0.01≤T1/T2≤0.125), and a ratio of the width T1 to the width T3 may range from 0.01 to 0.2 (that is, 0.01≤T1/T3<0.2). Specifically, in the present disclosure, when the width T1 and the spacing T2 of the data lines DL and the width T3 of the active layer AL in a circuit layer CL satisfy the above-mentioned relationship, the electronic device ED including the circuit layer CL may be regarded as the display device with high resolution.

Referring to FIG. 1, according to the present disclosure, the plurality of active layers AL in the circuit layer CL may include the first active layer AL1 and the second active layer AL2, wherein the second active layer AL2 is adjacent to the first active layer AL1, or the first active layer AL1 and the second active layer AL2 are two active layers AL adjacent to each other. “The first active layer AL1 is adjacent to the second active layer AL2” described herein may represent that the first active layer AL1 and the second active layer AL2 are two active layers AL arranged sequentially along an arranging direction, wherein the “arranging direction” may be the arranging direction of the plurality of active layers AL mentioned above, such as the direction X or the direction Y, or in other words, a direction perpendicular to the extending direction of the scan line SL or a direction parallel to the extending direction of the scan line SL. In other words, in the present embodiment, two active layers AL sequentially arranged along the direction X (or the direction Y) may be regarded as the two active layers AL adjacent to each other.

For example, in FIG. 1, the first active layer AL1 and the second active layer AL2 may be two active layers AL sequentially arranged along the direction Y, and therefore, it can be defined that the first active layer AL1 and the second active layer AL2 are adjacent to each other, but not limited thereto. In some embodiments, the third active layer AL3 and the first active layer AL1 sequentially arranged along the direction X may be regarded as the two active layers AL adjacent to each other. When it is mentioned that “an active layer AL is adjacent to another active layer AL” in the following, the definition thereof may refer to the contents above, and will not be redundantly described.

According to the present disclosure, the first active layer AL1 may include a first end E1, and the second active layer AL2 adjacent to the first active layer AL1 may include a second end E2, wherein the second end E2 of the second active layer AL2 is adjacent to the first end E1 of the first active layer AL1. Specifically, in the present disclosure, an active layer AL may include a channel region CR and the ends EE respectively located at two sides of the channel region CR. In detail, as shown in FIG. 1, a portion of the active layer AL corresponding to the scan line SL may be defined as the channel region CR, a portion of the active layer AL at a side of the channel region CR may be regarded as an end EE, and another portion of the active layer AL at another side of the channel region CR may be regarded as another end EE. In such condition, one of the ends EE of the active layer AL may be the source region SR, and another one of the ends EE of the active layer AL may be the drain region DR. After the two ends EE of the active layer AL are defined, an end EE of an active layer AL closer to another active layer AL which is adjacent to the active layer AL and another end EE of the another active layer AL closer to the active layer AL may be regarded as the two ends adjacent to each other, that is, the first end E1 and the second end E2 mentioned above. One of the first end E1 and the second end E2 may be the source region SR, and another one of the first end E1 and the second end E2 may be the drain region DR. Taking the structure shown in FIG. 1 as an example, the end EE of the first active layer AL1 closer to the second active layer AL2 which is adjacent to the first active layer AL1 may be the first end E1, and the end EE of the second active layer AL2 closer to the first active layer AL1 may be the second end E2, wherein the second end E2 is adjacent to the first end E1. In such condition, the first end E1 of the first active layer AL1 may be the source region SR of the first active layer AL1, that is, the first end E1 of the first active layer AL1 may be electrically connected to the data line DL, and the first end E1 may at least partially overlap the data line DL in the top view of the electronic device ED; the second end E2 of the second active layer AL2 may be the drain region DR of the second active layer AL2, that is, the second end E2 of the second active layer AL2 may be electrically connected to the conductive layer M4, and the second end E2 may at least partially overlap the conductive layer M4 in the top view of the electronic device ED. In addition, in the top view of the electronic device ED, the second end E2 of the second active layer AL2 and the metal lines ML may be separated from each other. Specifically, in the top view of the electronic device ED, the second end E2 of the second active layer AL2 may not overlap the data lines DL and/or the scan lines SL. It should be noted that the first end E1 and the second end E2 adjacent to the first end E1 mentioned above may be defined in any two adjacent active layers, which is not limited to the first active layer AL1 and the second active layer AL2 shown in FIG. 1. Specifically, after two adjacent active layers AL are defined through the above-mentioned way, a source region SR and a drain region DR respectively in the two adjacent active layers AL and adjacent to each other and may be defined as the first end E1 and the second end E2.

In addition, in the present embodiment, an end EE of the active layer AL may have an edge EG, wherein the edge EG may be defined as the portion of the edge of the active layer AL corresponding to the end EE. For example, as shown in FIG. 1, the first end E1 of the first active layer AL1 may have an edge EG1 (shown in a bold line in FIG. 1), and the second end E2 of the second active layer AL2 may have an edge EG2 (shown in a bold line in FIG. 1).

Referring to FIG. 3, FIG. 3 shows an enlarged view of the portion PP of the top view structure shown in FIG. 1. According to the present disclosure, in the top view of the electronic device ED, a portion of the first end E1 of the first active layer AL1 (for example, the portion of the first end E1 at the end) may extend toward the extending direction of the data line DL (that is, the first direction DR1, such as the direction Y) and extend beyond the edge EO of the first opening OP1 (or the opening OPA) used for electrically connecting the data line DL to the source region SR of the first active layer AL1, or in other words, a portion of the first end E1 may extend toward the direction Y and protrude from the edge EO of the first opening OP1. “The edge EO of the first opening OP1” described herein may be the edge of the shape of the bottom profile or the top profile of the first opening OP1 in the top view of the electronic device ED. In addition, “the portion of the first end E1 extends beyond (or protrude from) the first opening OP1” described herein may refer to the situation that a portion of the first end E1 extends from inside the first opening OP1 to outside the first opening OP1. For example, the first end E1 may extend from a region exposed by the first opening OP1 to a region not exposed by the first opening OP1. When it is mentioned that “the portion of the first end E1 extends beyond (or protruded from) an element” in the following, the definition thereof may refer to the definition described herein, and will not be redundantly described. In such condition, in the top view of the electronic device ED, the first end E1 of the first active layer AL1 may have an edge EG1, wherein a portion of the edge EG1 may be arc-shaped and located between the first opening OP1 and the second end E2 of the second active layer AL2. “A portion of the edge EG1 is arc-shaped” described herein may represent that the portion of the edge EG1 includes an arc segment. According to the present disclosure, “the edge EG1 is located between the first opening OP1 and the second end E2” mentioned above may be defined through the following way. First, a virtual straight line (that is, the straight line L1) may be defined, wherein the virtual straight line connects a point P1 on the edge EO of the first opening OP1 and a point P2 on the edge EG2 of the second end E2, and the distance between the point P1 and the point P2 is the minimum distance between the edge EO and the edge EG2 (shown in FIG. 3). In such condition, the virtual straight line may pass through a point (such as the point P5) on the edge EG1 of the first end E1, and the point is included in the arc-shaped portion of the edge EG1, but not limited thereto. It should be noted that in other embodiments, the first end E1 may include a portion having any suitable non-linear shape, which is not limited to the arc shape mentioned above.

In short, according to the present disclosure, the electronic device ED may include the first active layer AL1 and the second active layer AL2 adjacent to the first active layer AL1 disposed on the substrate SB, wherein the first active layer AL1 and the second active layer AL2 respectively include the first end E1 and the second end E2 adjacent to the first end E1. The electronic device ED further includes the insulating layer disposed on the first active layer AL1 and the second active layer AL2, wherein the “insulating layer” described herein may include a single-layer structure or a multi-layer structure. For example, the “insulating layer” described herein may include the insulating layer IN3 and the insulating layer IN4 shown in FIG. 13, but not limited thereto. In some embodiments, the “insulating layer” may only include the insulating layer IN4. The electronic device ED further includes the metal line ML disposed on the insulating layer, that is, the data line DL, and in the cross-sectional view of the electronic device ED (as shown in FIG. 13), a portion of the metal line ML (that is, the data line DL) is disposed in the first opening OP1 and overlaps the first end E1, and in the top view of the electronic device ED (as shown in FIG. 3), the first end E1 has the edge EG1, wherein a portion of the edge EG1 is arc-shaped and located between the first opening OP1 and the second end E2. In other words, the arc-shaped portion of the edge EG1, the first opening OP1 and the second end E2 may respectively have an orthographic projection on the substrate SB, wherein the orthographic projection of the arc-shaped portion of the edge EG1 may be located between the orthographic projection of the first opening OP1 and the orthographic projection of the second end E2. It should be noted that the features above may be applied to the first end E1 and the second end E2 defined through any two adjacent active layers AL.

As mentioned above, a portion of the first end E1 may extend toward the extending direction (that is, the first direction DR1) of the data line DL and extend beyond (or protrude from) the edge EO of the first opening OP1 in the top view of the electronic device ED. According to the present disclosure, as shown in FIG. 3, in the top view of the electronic device ED, the portion of the first end E1 may extend beyond the first opening OP1 (or the edge EO of the first opening OP1) in the first direction DR1, wherein a distance Y1 may be included between the portion of the first end E1 and the first opening OP1 in the first direction DR1, and the distance Y1 may be less than 2 micrometers (μm) (that is, Y1<2 μm). Specifically, the distance Y1 is greater than 0 and less than 2 μm (that is, 0<Y1<2 μm), but not limited thereto. In some embodiments, the distance Y1 is greater than 0.5 μm and less than 2 μm (that is, 0.5 μm<Y1<2 μm). In some embodiments, the distance Y1 is greater than 1 μm and less than 2 μm (that is, 1 μm<Y1<2 μm). According to the present embodiment, the distance Y1 may be defined through the following way. First, the geometric center GS of the shape of the first opening OP1 in the top view may be confirmed, and a straight line L2 passing through the geometric center GS of the first opening OP1 and extending along the first direction DR1 may be defined, wherein the straight line L2 may pass through a point P3 on the edge EO of the first opening OP1 and a point P4 on the edge EG1 of the first end E1. In such condition, the distance Y1 may be the linear distance between the point P3 and the point P4. That is, the distance Y1 may be measured in the first direction DR1. In other embodiments, the distance Y1 may be defined through other suitable ways, which is not limited to the method mentioned above. In the present disclosure, the portion of the first end E1 protruding from the first opening OP1 may have any suitable shape (not limited to the shape shown in FIG. 3), such that the distance Y1 may satisfy the above-mentioned condition. The distance Y1 may also be regarded as the protruding distance of the first end E1 from the first opening OP1 in the top view of the electronic device ED. The distance Y1 may be used to represent the degree to which the first end E1 protrudes from the first opening OP1, wherein when the distance Y1 is greater, the proportion of the portion of the first end E1 that protrudes from the first opening OP1 to the first end E1 will increase.

FIG. 2 also shows the feature of the distance Y1. In detail, FIG. 2 shows the cross-sectional structure of the structure shown in FIG. 1 along a section line A-A′. In order to simplify the figure, FIG. 2 just shows some of the layers or elements of the electronic device ED. Specifically, the cross-sectional structure shown in FIG. 2 may be the cross-sectional structure of the electronic device ED along the section line A-A′ parallel to the extending direction (that is, the first direction DR1) of the data line DL. As shown in FIG. 2, the data line DL may be electrically connected to the source region SR of the first active layer AL1 through the first opening OP1 penetrating the insulating layer INL. In some embodiments, the insulating layer INL includes the insulating layer IN3 and the insulating layer IN4 shown in FIG. 13, that is, the insulating layer INL is a composite layer. In some embodiments, the insulating layer INL may be the insulating layer IN4 shown in FIG. 13. As shown in FIG. 2, the distance Y1 may be included between the first end E1 of the first active layer AL1 and the first opening OP1 in the first direction DR1, wherein the range of the distance Y1 may refer to the contents above. It should be noted that although the distance Y1 shown in FIG. 2 is the distance between the edge of the bottom profile of the first opening OP1 and the edge EG1 of the first end E1 in the first direction DR1, it is not limited in the present disclosure.

In some embodiments, the distance Y1 may be the distance between the edge of the top profile of the first opening OP1 and the edge EG1 of the first end E1 in the first direction DR1.

According to the present embodiment, by making the first end E1 of the first active layer AL1 protrude from the first opening OP1 in the extending direction of the data line DL and making the distance Y1 fall within the above-mentioned range, the situation that the data line DL is disconnected due to the disposing range of the first opening OP1 exceeding the active layer AL may be reduced while reducing the influence on the layout space of the pixels, thereby improving the process yield of the electronic device ED. Specifically, in current display devices with high resolution, limited by the narrow layout space of the pixels, when the an opening is formed in the insulating layer through a mask, a portion of the mask may fall outside the active layer in the top view of the display device, such that the insulating layer(s) below the active layer may further be removed in the exposure process, that is, a portion of the opening may be formed by further removing a portion of the insulating layer(s) below the active layer, thereby forming a deep trench. In such condition, when the data line is disposed in the opening in subsequent process, the data line may be disconnected, thereby affecting the process yield of the display device. In another aspect, in the present disclosure, after the position of the mask used to form the first opening OP1 is confirmed, the first active layer AL1 may be made to protrude from the mask by compensating the first active layer AL1 (for example, making the first active layer AL1 protrude from the mask by the distance Y1 in the top view, but not limited thereto), such that the problem of the process of the opening mentioned above may be reduced. In other words, the distance Y1 mentioned above may also be called as the compensating distance of the first active layer AL1, which is used for reducing the situation that the data line DL disposed in the first opening OP1 is disconnected due to the portion of the first opening OP1 falling outside the first active layer AL1. In addition, the compensating direction of the first active layer AL1 may be defined as the first direction DR1, or in other words, the first active layer AL1 may be compensated toward the first direction DR1. Therefore, the process yield of the electronic device ED of the present disclosure may be improved while the electronic device ED has high resolution. It should be noted that the feature of the distance Y1 mentioned above may be applied to any active layer AL, which is not limited to the first active layer AL1.

As shown in FIG. 3, in some embodiments, in the top view of the electronic device ED, a minimum distance DS1 may be included between the first end E1 of the first active layer AL1 and the second end E2 of the second active layer AL2, wherein the minimum distance DS1 may be greater than or equal to 0.5 μm (that is, 0.5 μm≤DS1). Specifically, the minimum distance DS1 may be greater than or equal to 0.5 μm and less than or equal to 1 millimeter (mm) (that is, 0.5 μm≤DS1≤1 mm), but not limited thereto. In some embodiments, the minimum distance DS1 may be greater than or equal to 0.5 μm and less than or equal to 0.5 mm (that is, 0.5 μm≤DS1≤0.5 mm). In some embodiments, the minimum distance DS1 may be greater than or equal to 0.5 μm and less than or equal to 0.2 mm (that is, 0.5 μm≤DS1≤0.2 mm). In the present embodiment, the minimum distance DS1 may be defined by any point on the edge EG1 of the first end E1 and any point on the edge EG2 of the second end E2. Specifically, after picking any point on the edge EG1 of the first end E1 and picking any point on the edge EG2 of the second end E2, a linear distance may be defined between the two points, and therefore, after a plurality of points are picked on the edge EG1 of the first end E1, and a plurality of points are picked on the edge EG2 of the second end E2 to define a plurality of linear distances, the smallest one of the plurality of linear distances may be defined as the above-mentioned minimum distance DS1. For example, as shown in FIG. 3, the distance between the point P5 on the edge EG1 of the first end E1 and the point P2 on the edge EG2 of the second end E2 may be the smallest distance among the plurality of distances defined by the plurality of points on the edge EG1 of the first end E1 and the plurality of points on the edge EG2 of the second end E2, and therefore, the distance between the point P5 and the point P2 may be the minimum distance DS1 mentioned above. It should be noted that the feature of the minimum distance DS1 mentioned above may be applied to the minimum distance between a first end E1 and a second end E2 defined by any two adjacent active layers AL. In some embodiments, the first active layer AL1 and the second active layer AL2 (or other active layers AL) may be located in the same layer; and in some other embodiments, the first active layer AL1 and the second active layer AL2 (or other active layers AL) may be located in different layers. It should be noted that regardless of whether the first active layer AL1 and the second active layer AL2 are located in the same layer, the above-mentioned minimum distance DS1 may be measured by observing the first active layer AL1 and the second active layer AL2 in the top view of the electronic device ED.

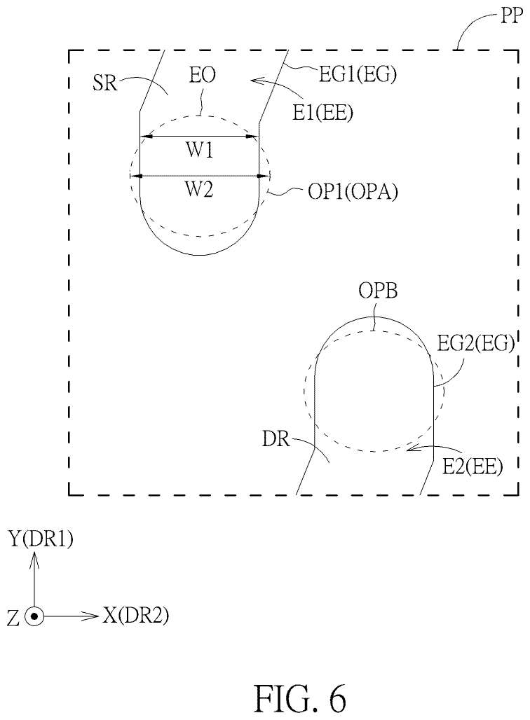

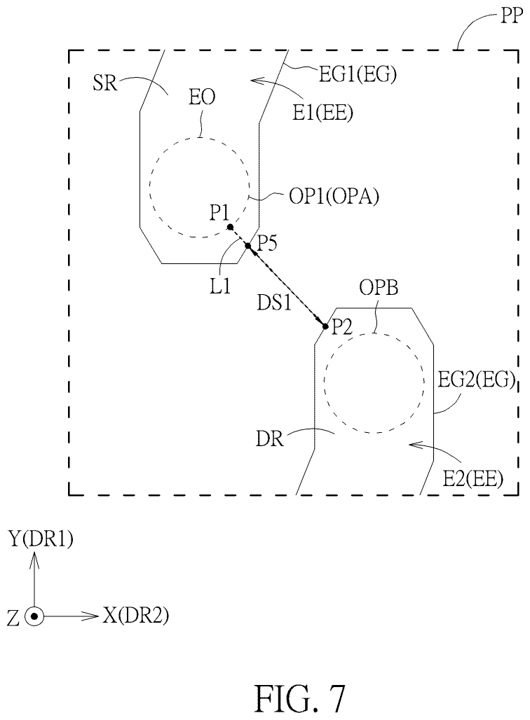

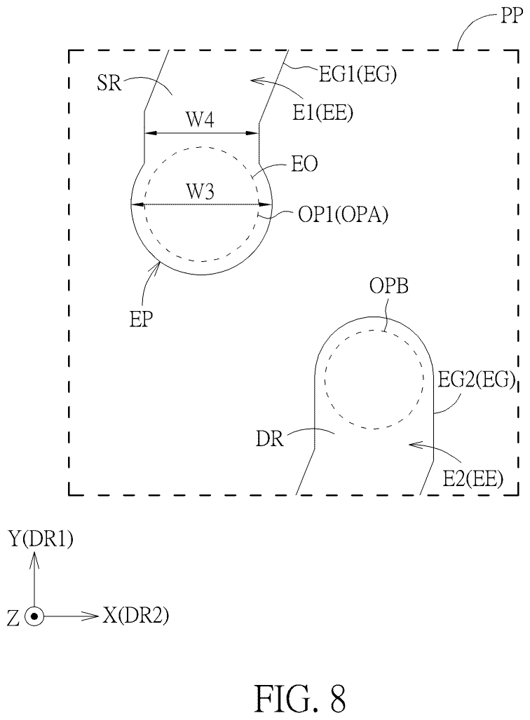

In the present embodiment, as shown in FIG. 3, the first opening OP1 may be aligned with the edge EG1 of the first end E1 of the first active layer ALL in the direction X, but not limited thereto. In some embodiments, the first opening OP1 shrinks in the direction X compared with the edge EG1. In some embodiments, the first opening OP1 may extend and protrude from (or extend beyond) the edge EG1 in the direction X (as shown in FIG. 6). In addition, in the present embodiment, the second end E2 of the second active layer AL2 may at least partially overlap the opening OPB in the top view of the electronic device ED, that is, the opening OPB is not completely overlapped with the second end E2, but not limited thereto. In other embodiments (for example, shown in FIG. 7 or FIG. 8), the second end E2 may completely overlap the opening OPB in the top view of the electronic device ED, or the disposing range of the second end E2 covers the disposing range of the opening OPB.

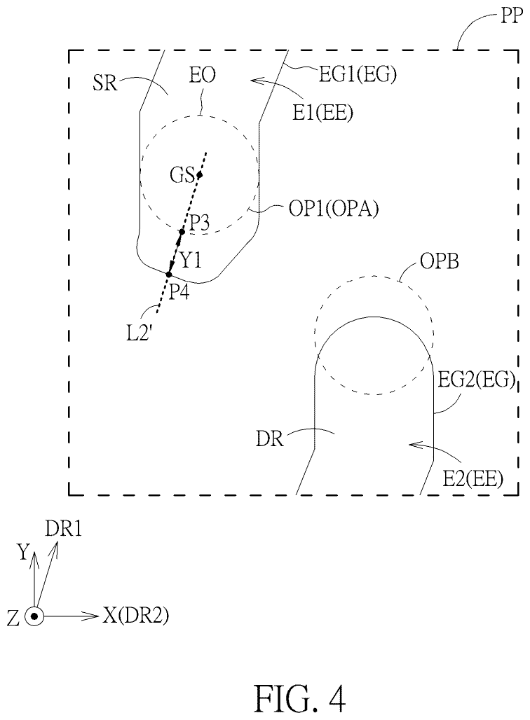

Referring to FIG. 4 to FIG. 8, FIG. 4 to FIG. 8 schematically illustrate partial enlarged top views of electronic devices according to variant embodiments of the first embodiment of the present disclosure. Specifically, FIG. 4 to FIG. 8 show different designs of the first end E1, the second end E2, the first opening OP1 and the opening OPB of the present embodiment.

As shown in FIG. 4, in the present variant embodiment, the extending direction DR1 of the data line DL may be an inclined direction not parallel to the direction X and the direction Y. In such condition, a portion of the first end E1 of the first active layer AL1 may for example extend beyond the first opening OP1 along the inclined direction in the top view of the electronic device ED. In other words, the compensating direction of the first active layer AL1 may be an inclined first direction DR1. Therefore, in the top view of the electronic device ED, an oblique line L2′ passing through the geometric center GS of the first opening OP1 and extending along the first direction DR1 may be defined at first, and the intersection (the point P3) of the oblique line L2′ and the edge EO of the first opening OP1 and the intersection (the point P4) of the oblique line L2′ and the edge EG1 of the first end E1 are confirmed, wherein the distance between the point P3 and the point P4 in the first direction DR1 may be the distance Y1 mentioned above. The portion of the first end E1 protruding from the first opening OP1 may include any suitable shape, such that the distance Y1 may satisfy the condition above. The features of the second end E2 and the opening OPB of the present variant embodiment may refer to the contents above, and will not be redundantly described.

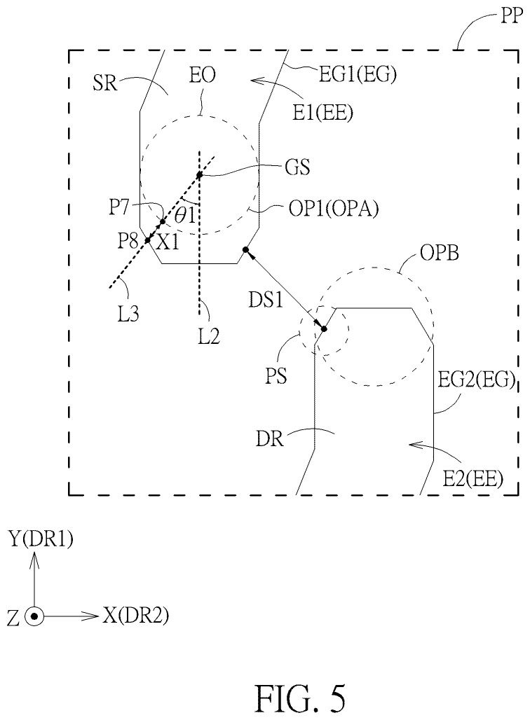

As shown in FIG. 5, in the present variant embodiment, in addition to being compensated toward the extending direction DR1 of the data line DL, the first active layer AL1 may also be compensated in other directions that are not parallel to the extending direction DR1. In such condition, a distance X1 between the edge EO of the first opening OP1 and the edge EG1 of the first end E1 may be defined through the following way, wherein the distance X1 may be defined in a direction not parallel to the first direction DR1. First, a straight line L2 passing through the geometric center GS of the first opening OP1 and extending along the first direction DR1 may be defined at first, and then another straight line L3 passing through the geometric center GS of the first opening OP1 and having an included angle θ1 with the straight line L2 may be defined, wherein the included angle θ1 may range from 20 degrees to 80 degrees (that is,) 20°≤θ1≤80°. Specifically, a value of the included angle θ1 may be selected in the range from 20 degrees to 80 degrees, and the straight line L3 mentioned above may be defined according to the value of the included angle θ1. After the straight line L3 is defined, the straight line L3 and the edge EO of the first opening OP1 may intersect at a point P7, the straight line L3 and the edge EG1 of the first end E1 may intersect at a point P8, and the length of the line segment in the straight line L3 between the point P7 and the point P8 may be defined as the distance X1 mentioned above. According to the present variant embodiment, the distance X1 may be less than 1 μm and greater than or equal to 0 (that is, 0≤X1<1 μm), but not limited thereto. In some embodiments, the distance X1 may be less than 0.9 μm and greater than or equal to 0 (that is, 0≤X1<0.9 μm). In some embodiments, the distance X1 may be less than 0.8 μm and greater than or equal to 0 (that is, 0≤X1<0.8 μm). If the distance X1 is greater than 1 μm, the layout space of other active layers AL adjacent to the first active layer AL1 (such as the second active layer AL2) may be limited. In other words, the portion of the first end E1 extending beyond (or protruding from) the first opening OP1 may include any suitable shape, such that the distance X1 may be located within the above-mentioned range. By making the first active layer FL1 further be compensated in other directions that are not parallel to the first direction DR1, the situation that the impedance between the data line DL and the first active layer AL1 is increased due to the reduction in the contact area between the data line DL and the first active layer AL1 may be reduced. The definition and range of the distance X1 mentioned above may be applied to other active layers AL. In addition, in the present variant embodiment, as shown in FIG. 5, the pattern of the second active layer AL2 adjacent to the first active layer AL1 may be designed, such that the minimum distance DS1 between the first active layer AL1 and the second active layer AL2 may increase (for example, making the minimum distance DS1 at least be greater than or equal to 0.5 μm) while the first active layer AL1 is compensated toward other directions that are not parallel to the first direction DR1. Therefore, the possibility that the process yield of the electronic device ED is affected due to connection between the first active layer AL1 and the second active layer AL2 during the manufacturing process of the electronic device ED may be reduced. For example, in the present variant embodiment, a corner cutting may be performed on the pattern of the second end E2 at the position (for example, the position PS shown in FIG. 5) adjacent to the first active layer AL1, such that the width of the end portion of the second end E2 adjacent to the first active layer AL1 may be less than the width of the other portion of the second end E2, but not limited thereto. In other words, the minimum distance DS1 may be increased, or the space for the first active layer AL1 to extend in other directions may be provided by removing (or cutting) at least a portion of the corner of the second end E2 adjacent to the first active layer AL1. It should be noted that in another embodiment, the active layer AL may be compensated through the ways shown in FIG. 3 and FIG. 5 at the same time.

According to the present disclosure, the first end E1 of the first active layer AL1 may have a width W1, and the first opening OP1 may have a width W2. The width W1 may be the width of a portion of the first end E1 extending along the extending direction (that is, the first direction DR1) of the data line DL. Specifically, in the top view of the electronic device ED, the width W1 may be defined as the maximum width of the portion of the first end E1 extending along the first direction DRI in the direction X (for example be the direction perpendicular to the first direction DR1), and the width W2 may be defined as the maximum width of the first opening OP1 (for example, the bottom of the first opening OP1) in the direction X. That is, the width W1 and the width W2 may be measured in the same direction (such as the direction X). According to the present disclosure, a ratio of the width W1 of the first end E1 to the width W2 of the first opening OP1 may be located between 0.5 and 2 (that is, 0.5<W1/W2<2), but not limited thereto. In other words, the width W1 may be greater than, equal to or less than the width W2. For example, as shown in FIG. 6, in the present variant embodiment, the width W1 of the first end E1 of the first active layer AL1 may be less than the width W2 of the first opening OP1. That is, the first opening OP1 may be protruded from the edge EG1 of the first end E1 in the direction X. In such condition, the ratio of the width W1 to the width W2 may be greater than 0.5 and less than 1 (that is, 0.5<W1/W2<1). In some embodiments, the width W1 and the width W2 may be the same (as shown in FIG. 3), and the ratio of the width W1 to the width W2 may be 1 in this case. In some embodiments, the width W1 may be greater than the width W2, and the ratio of the width W1 to the width W2 may be greater than 1 and less than 2 in this case (that is, 1<W1/W2<2). The relationship between the width of the second end E2 and the opening OPB may refer to the relationship between the width W1 and the width W2 mentioned above, and will not be redundantly described.

As shown in FIG. 7, in the present variant embodiment, the portion of the edge EG1 located between the first opening OP1 and the edge EG2 of the second end E2 may not include arc-shaped segment. Specifically, as shown in FIG. 7, a virtual straight line (that is, the straight line L1) passing through the point P1 on the edge EO and the point P2 on the edge EG2 may be defined through the above-mentioned way at first, wherein the straight line L1 will pass through a point (such as the point P5) on the edge EG1 of the first end E1, and the point may be included in a linear segment of the edge EG1. It should be noted that although it is not shown in FIG. 7, a portion of the edge EG1 of the first end E1 and a portion of the edge EG2 of the second end E2 may include arc-shaped segment.

As shown in FIG. 8, in the present variant embodiment, the first end E1 of the first active layer AL1 may have an end portion EP, wherein the end portion EP may for example be the portion of the first end E1 used for connecting the first opening OP1. In detail, in the top view of the electronic device ED, the first opening OP1 may overlap the end portion EP of the first end E1. The end portion EP of the first end E1 may have a width W3, and the other portion of the first end E1 may have a width W4, wherein the width W3 may be greater than the width W4. The width W3 may be defined as the maximum width of the end portion EP in the direction X, and the width W4 may be defined as the maximum width of the other portion of the first end E1 in the direction X. In other words, the maximum width (that is, the width W3) of the portion of the first end E1 at its end (that is, the end portion EP) in the direction X may be greater than the maximum width (that is, the width W4) of the other portion of the first end E1 in the direction X. Through the above-mentioned design, the size of the portion of the first end E1 overlapped with the first opening OP1 may increase, such that the situation that the data line DL is disconnected due to the range of the first opening OP1 falling outside the first end E1 may be reduced. In some embodiments, the width W3 of the end portion EP may be greater than the maximum width of the channel region CR of the first active layer AL1 in the direction X.

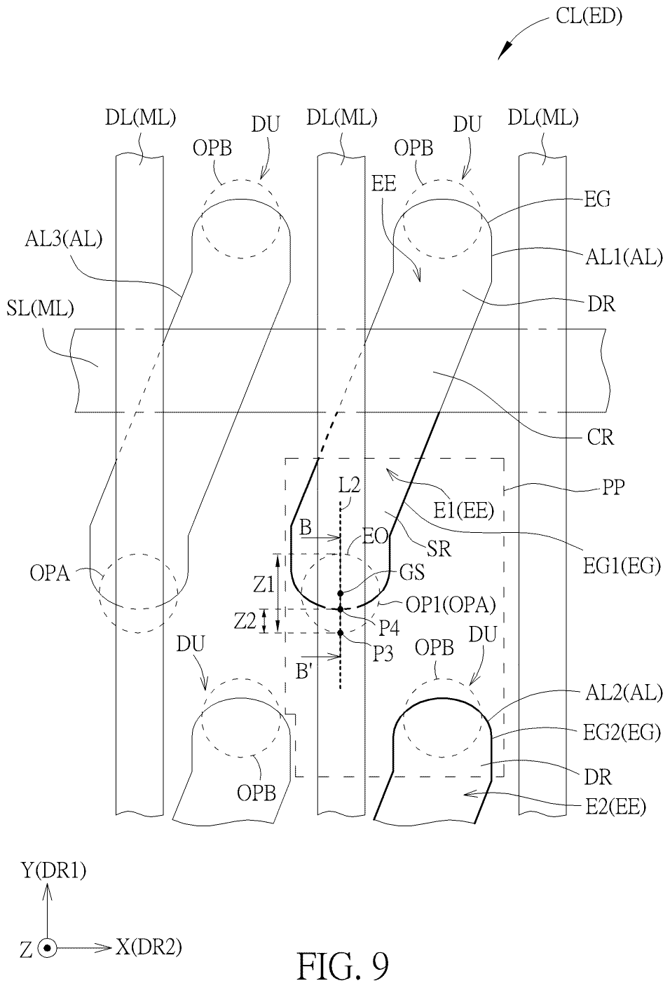

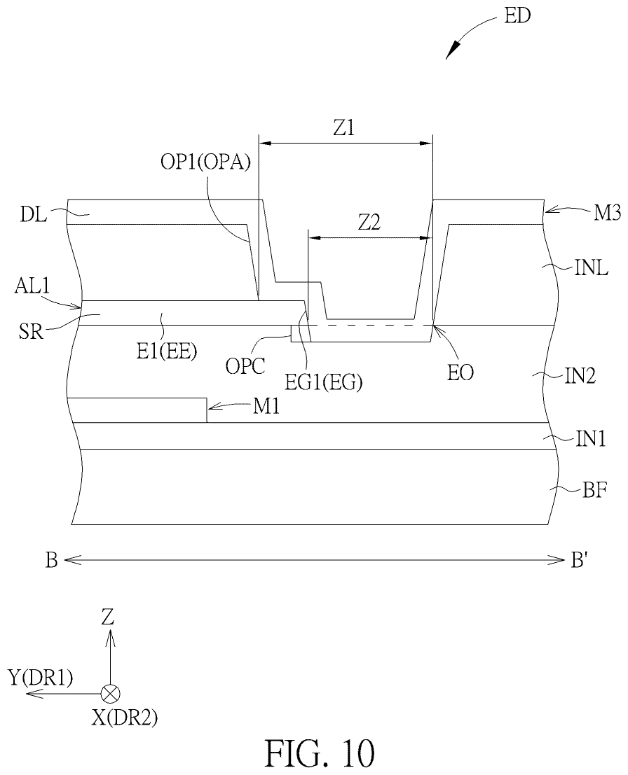

Referring to FIG. 9 and FIG. 10, FIG. 9 schematically illustrates a top view of an electronic device according to a second embodiment of the present disclosure, and FIG. 10 schematically illustrates a cross-sectional view of the electronic device according to the second embodiment of the present disclosure. In order to simplify the figure, FIG. 10 just shows some of the layers and elements of the electronic device ED. Specifically, the cross-sectional structure shown in FIG. 10 may be a cross-sectional structure of the electronic device ED along the section line B-B′ parallel to the extending direction of the data line DL (that is, the first direction DR1). According to the present embodiment, in the top view of the electronic device ED, the edge EO of the first opening OP1 may extend beyond (or protrude from) the edge EG1 of the first end E1 of the first active layer AL1. For example, the edge EO of the first opening OP1 may extend toward the extending direction (that is, the first direction DR1) of the data line DL and extend beyond the edge EG1 of the first end E1, but not limited thereto. In such condition, in the top view of the electronic device ED, a portion of the first opening OP1 may not overlap the first end E1, or the first opening OP1 may not completely overlap the first end E1.

Specifically, in the manufacturing process of the electronic device ED, the mask used to form the first opening OP1 may extend beyond the first end E1 of the first active layer AL1 (for example, extend beyond the first end E1 toward the first direction DR1), such that the formed first opening OP1 may extend beyond the first end E1. In such condition, as shown in FIG. 10, when removing a portion of the insulating layer INL located on the first active layer AL1 to form the first opening OP1, a portion of the insulating layer IN2 may also be removed to form an opening OPC. That is, the insulating layer INL surrounds the first opening OP1, and the insulating layer IN2 surrounds the opening OPC. In addition, the first opening OP1 may expose a portion of the active layer AL. The feature of the insulating layer INL may refer to FIG. 2 and related contents above, and will not be redundantly described. In other words, compared with the structures in the above-mentioned embodiments, in the present embodiment, in addition to the first opening OP1, the opening OPC may further be formed by removing a portion of the insulating layer IN2. In such condition, the data line DL may be disposed in the first opening OP1 and the opening OPC, wherein a portion of the data line DL may contact the first active layer AL1, and another portion of the data line DL may be disposed on the insulating layer IN2 or extend on the insulating layer IN2.

According to the present embodiment, the first opening OP1 is surrounded by the insulating layer INL, the first opening OP1 may have a width Z1 in the extending direction of the data line DL (that is, the first direction DR1, which may for example be the direction Y in the present embodiment), and a distance Z2 may be included between the edge EG1 of the first end E1 of the first active layer AL1 and the edge EO of the first opening OP1 in the extending direction of the data line DL, wherein the distance Z2 is greater than or equal to ¼ times the width Z1 and less than or equal to ¾ times the width Z1 (that is, ¼≤Z1≤Z2≤¾Z1), but not limited thereto. In the top view of the electronic device ED (as shown in FIG. 9), the width Z1 may be defined as the maximum width of the projection of the bottom profile of the first opening OP1 on a plane perpendicular to the direction Z in the first direction DR1. In other words, in a cross-sectional view parallel to the extending direction of the data line DL (as shown in FIG. 10), the width Z1 may be the maximum distance between a side and the other side of the bottom of the first opening OP1 in the first direction DR1. The distance Z2 may be defined through the following way. Specifically, a straight line L2 passing through the geometric center GS of the first opening OP1 and extending along the first direction DR1 may be defined, wherein the straight line L2 may intersect the edge EO of the first opening OP1 at a point P3 and intersect the edge EG1 of the first end E1 at a point P4, and the distance Z2 may be the linear distance between the point P3 and the point P4. The edge EO of the first opening OP1 described herein may be the edge of the bottom of the first opening OP1. In other words, the edge EO surrounds (or defines) the bottom profile of the first opening OP1. Specifically, in the cross-sectional view of the electronic device ED, the distance Z2 may be the distance between the edge EG1 of the first end E1 of the first active layer AL1 and the bottom of the sidewall of the first opening OP1 (that is, the junction of the insulating layer IN2 and the insulating layer INL) in the direction Y. In addition, in the cross-sectional view of the electronic device ED (as shown in FIG. 10), the distance Z2 may be the minimum distance between the edge EG1 of the first end E1 and a side (the side extends beyond the first end E1) of the bottom of the first opening OP1 in the first direction DR1.

In such condition, the distance Z2 may be regarded as the distance of the first opening OP1 extending beyond the first end E1 of the first active layer ALL in the first direction DR1. By making the distance 22 and the width Z1 satisfy the relationship mentioned above, the situation of disconnection of the data line DL may be reduced, thereby improving the process yield. Specifically, when the distance Z2 is less than ¼ times the width Z1, the length of the portion of the data line DL extending on the insulating layer IN2 may not be enough. In detail, a narrow deep trench structure (that is, the opening OPC) may be formed in the insulating layer IN2 during the etching step, making it difficult for the data line DL to extend on the insulating layer IN2, thereby increasing the risk of disconnection of the data line DL. When the distance Z2 is greater than ¾ times the width Z1, the distance between the first opening OP1 and other openings (such as the opening OPB overlapping the second active layer AL2) may be too small, thereby increasing the possibility that the first opening OP1 is overlapped with the opening OPB, or the contact area between the data line DL and the first active layer AL1 may be too small, resulting in poor conductive effect, or the subsequent patterning process of the conductive layer M4 (the detail thereof will be described in the following) may be affected, thereby increasing the risk of short circuit.

It should be noted that the above-mentioned features may be applied to other openings OPA used for electrically connecting the data lines DL and other active layers AL, which is not limited to the first opening OP1 mentioned above.

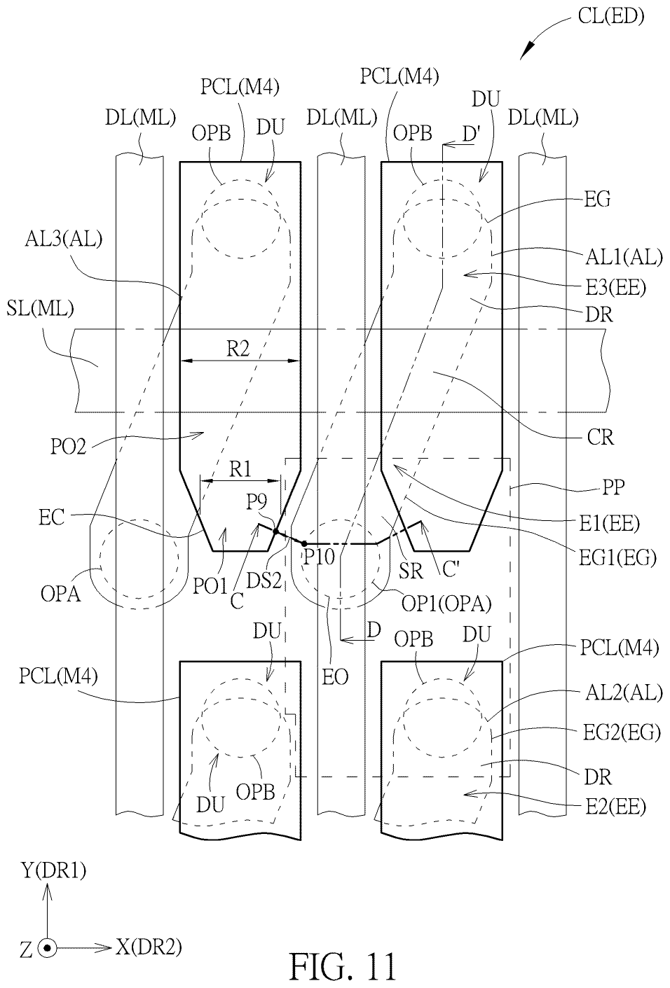

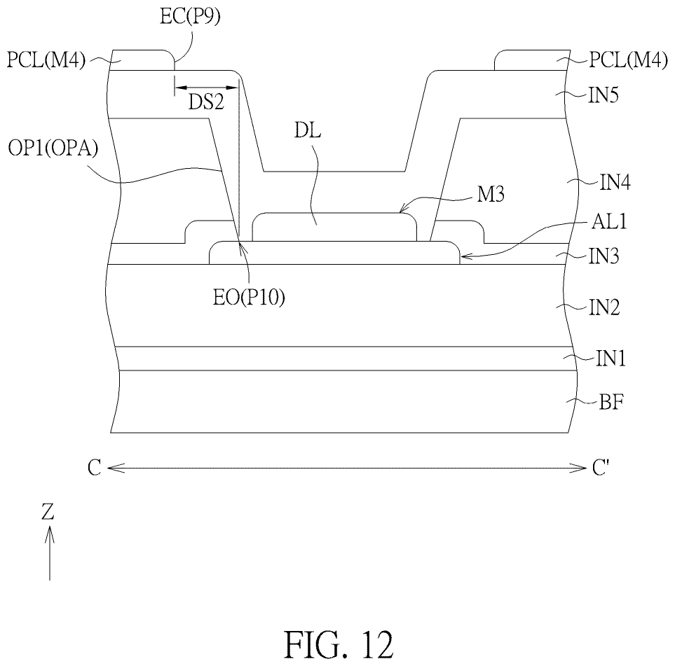

Referring to FIG. 11 to FIG. 13, FIG. 11 schematically illustrates a top view of an electronic device according to a third embodiment of the present disclosure, FIG. 12 schematically illustrates a cross-sectional view of the electronic device according to the third embodiment of the present disclosure, and FIG. 13 schematically illustrates a cross-sectional view of the electronic device according to the third embodiment of the present disclosure. Specifically, FIG. 12 shows the cross-sectional structure of the structure shown in FIG. 11 along a section line C-C′, and a portion of the structure shown in FIG. 13 is the cross-sectional structure of the structure shown in FIG. 11 along a section line D-D′. In order to simplify the figure, FIG. 12 just shows some of the layers and elements of the electronic device ED. According to the present embodiment, the electronic device ED may further include a pixel electrode and patterned conductive layers PCL disposed on the insulating layer IN3, the insulating layer IN4 and the insulating layer IN5, wherein the pixel electrode is the above-mentioned electrode EL1, and the patterned conductive layers PCL are portions of the conductive layer M4. Specifically, in the present disclosure, the conductive layer M4 may be patterned and form a plurality of patterned conductive layers PCL, and a pixel electrode (that is, the electrode EL1) may be electrically connected to an active layer AL (or the drain region DR of the active layer AL) through one of the plurality of patterned conductive layers PCL. For example, a pixel electrode may be electrically connected to the drain region DR of the first active layer AL1 through a patterned conductive layer PCL. The plurality of patterned conductive layers PCL may be electrically isolated from each other, that is, the plurality of patterned conductive layers PCL may not be electrically connected to each other. In detail, in the top view of the electronic device ED, the first active layer AL1 further includes a third end E3, wherein the third end E3 may be the drain region DR of the first active layer AL1. The third end E3 and the metal lines ML are isolated from each other. Specifically, in the top view of the electronic device ED, the third end E3 of the first active layer AL1 may not overlap the data lines DL and/or the scan lines SL. One of the patterned conductive layers PCL may be electrically connected to the third end E3 of the first active layer AL1 through the opening OPB mentioned above, wherein the opening OPB may be disposed in the insulating layer IN3, the insulating layer IN4 and the insulating layer IN5 located on the first active layer AL1 (as shown in FIG. 13), or the opening OPB may be formed by removing a portion of the insulating layer IN3, a portion of the insulating layer IN4 and a portion of the insulating layer IN5, but not limited thereto.

According to the present embodiment, in the top view of the electronic device ED (as shown in FIG. 11), a minimum distance DS2 may be included between one of the plurality of patterned conductive layers PCL and the first opening OP1, wherein the minimum distance DS2 may be greater than 0.1 μm (that is, 0.1 μm<DS2). Specifically, the minimum distance DS2 may be greater than 0.1 μm and less than 1 mm (that is, 0.1 μm<DS2<1 mm), but not limited thereto. In some embodiments, the minimum distance DS2 may be greater than 0.1 μm and less than 0.8 mm (that is, 0.1 μm<DS2<0.8 mm). In some embodiments, the minimum distance DS2 may be greater than 0.1 μm and less than 0.6 mm (that is, 0.1 μm<DS2<0.6 mm). “The minimum distance DS2 between one of the plurality of patterned conductive layers PCL and the first opening OP1” mentioned above may represent that the minimum distance DS2 is included between the first opening OP1 and the patterned conductive layer PCL adjacent to the first opening OP1 (such as the patterned conductive layer PCL electrically connected to the first active layer AL1 or the patterned conductive layer PCL electrically connected to the third active layer AL3). The definition of the minimum distance DS2 may refer to the definition of the minimum distance DS1 mentioned above. Specifically, after picking any point on the edge EC of the patterned conductive layer PCL adjacent to the first opening OP1 and picking any point on the edge EO of the first opening OP1, a distance may be defined through the two points, and therefore, after picking a plurality of points on the edge EC and picking a plurality of points on the edge EO to define a plurality of distances, the smallest one of the plurality of distances may be defined as the minimum distance DS2. For example, as shown in FIG. 11, the distance between the point P9 on the edge EC of the patterned conductive layer PCL adjacent to the first opening OP1 and the point P10 on the edge EO of the first opening OP1 may be the smallest distance among the plurality of distances defined by the plurality of points on the edge EC and the plurality of points on the edge EO, and therefore, the distance between the point P9 and the point P10 may be the minimum distance DS2. Referring to FIG. 12, the minimum distance DS2 may for example be measured from the edge EC of the patterned conductive layer PCL to the bottom of the first opening OP1. Therefore, the edge EO of the first opening OP1 mentioned above may be the edge of the bottom of the first opening OP1, and the point P10 may be a point on the edge of the bottom of the first opening OP1.

According to the present embodiment, the pattern of the patterned conductive layer PCL may be designed to facilitate the minimum distance DS2 between the patterned conductive layer PCL and the first opening OP1 satisfy the above-mentioned relationship. Specifically, when designing the pattern of the patterned conductive layer PCL, the portion of the pattern of the patterned conductive layer PCL adjacent to the first opening OP1 (or other openings OPA) may be removed, thereby increasing the minimum distance DS2 between the patterned conductive layer PCL and the first opening OP1. For example, in the present embodiment, a corner cutting may be performed on the corner of the pattern of the patterned conductive layer PCL close to the first opening OP1 or other openings OPA to form the pattern shown in FIG. 11. The pattern of the patterned conductive layer PCL may for example include a chamfer structure after the corner cutting process mentioned above, but not limited thereto. Specifically, in the process of patterning the conductive layer M4 to form the patterned conductive layers PCL, the corner cutting process may be performed on the pattern of the mask used for forming the patterned conductive layers PCL, wherein the corners of the mask close to the first opening OP1 and other openings OPA may be cut, thereby forming the patterned conductive layers PCL shown in FIG. 11. In such condition, the width of the portion of the patterned conductive layer PCL located between two adjacent openings OPA may be less than the width of the portion of the patterned conductive layer PCL not located between two adjacent openings OPA. In detail, as shown in FIG. 11, a patterned conductive layer PCL may include a portion PO1 overlapped with at least one of the two openings OPA located at two sides of the patterned conductive layer PCL in the direction X and a portion PO2 not overlapped with the two openings OPA in the direction X. The portion PO2 may be the other portion of the patterned conductive layer PCL except the portion PO1. The portion PO1 may have a width R1, and the portion PO2 may have a width R2, wherein the width R1 may be less than the width R2. The width R1 may be defined as the maximum width of the portion PO1 in the direction X, and the width R2 may be defined as the maximum width of the portion PO2 in the direction X.

According to the present embodiment, through the design of the minimum distance DS2 mentioned above, the disposition range of the patterned conductive layer PCL may not be located within the first opening OP1, thereby reducing the situation that the conductive layer M4 disposed corresponding to the first opening OP1 cannot be effectively removed due to insufficient exposure intensity during the patterning process of the conductive layer M4, such that the possibility of short circuit caused by connection between adjacent patterned conductive layers PCL may be reduced. The feature of the patterned conductive layer PCL described in the present embodiment may be applied to the embodiments and variant embodiments mentioned above.

In summary, an electronic device with high resolution is provided by the present disclosure, wherein the electronic device includes active layers, openings used for electrically connecting the data lines to the active layers and patterned conductive layers used for electrically connecting the pixel electrodes to the active layers. In some embodiments, through the position designs and/or the size designs of the active layer and the opening, the risk of disconnection of the data line in the opening may be reduced. In some embodiments, through the pattern design of the patterned conductive layer, the influence of the opening on the manufacturing process of the patterned conductive layer may be reduced. Therefore, the process yield of the electronic device may be improved.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a substrate;
a first active layer disposed on the substrate and including a first end;
a second active layer disposed on the substrate and including a second end, wherein the second end is adjacent to the first end;
an insulating layer disposed on the first active layer and the second active layer; and
a metal line disposed on the insulating layer, wherein in a cross-sectional view of the electronic device, the insulating layer surrounds a first opening, a portion of the metal line is disposed in the first opening and overlapped with the first end, and in a top view of the electronic device, the first end has an edge, and a portion of the edge is arc-shaped and located between the first opening and the second end.

2. The electronic device of claim 1, wherein in the top view of the electronic device, the metal line and a portion of the first end extend along a first direction.

3. The electronic device of claim 2, wherein in the top view of the electronic device, the portion of the first end extends beyond the first opening in the first direction, and a distance between the portion of the first end and the first opening in the first direction is less than 2 micrometers.

4. The electronic device of claim 3, wherein the distance between the portion of the first end and the first opening in the first direction is greater than 1 micrometer.

5. The electronic device of claim 1, wherein the metal line comprises a scan line or a data line.

6. The electronic device of claim 1, wherein the metal line is electrically connected to the second active layer through another opening.

7. The electronic device of claim 1, further comprising another metal line adjacent to the metal line, wherein the metal line has a width, a spacing is included between the metal line and the another metal line, and a ratio of the width of the metal line to the spacing ranges from 0.01 to 0.125.

8. The electronic device of claim 7, wherein the first active layer has another width, and a ratio of the width of the metal line to the another width of the first active layer ranges from 0.01 to 0.2.

9. The electronic device of claim 1, wherein the first active layer and the second active layer respectively comprise a source region, a drain region and a channel region located between the source region and the drain region, the first end is one of the source region and the drain region, and the second end is another one of the source region and the drain region.

10. The electronic device of claim 1, further comprising a pixel electrode and a plurality of patterned conductive layers disposed on the insulating layer, wherein a first minimum distance is included between one of the plurality of patterned conductive layers and the first opening, and the pixel electrode is electrically connected to the first active layer through the one of the plurality of patterned conductive layers.

11. The electronic device of claim 10, wherein the plurality of patterned conductive layers are electrically isolated from each other.

12. The electronic device of claim 10, wherein in the top view of the electronic device, the first active layer further includes a third end, the third end and the metal line are isolated from each other, the insulating layer further includes a second opening, and the one of the plurality of patterned conductive layers is electrically connected to the third end through the second opening.

13. The electronic device of claim 12, wherein the first active layer comprises a source region, a drain region and a channel region located between the source region and the drain region, the first end is one of the source region and the drain region, and the third end is another one of the source region and the drain region.

14. The electronic device of claim 10, wherein the first minimum distance is greater than 0.1 micrometers.

15. The electronic device of claim 14, wherein the first minimum distance is less than 0.6 millimeters.

16. The electronic device of claim 10, wherein the one of the plurality of patterned conductive layers includes a first portion overlapped with the first opening and a second portion not overlapped with the first opening, and a width of the first portion is less than a width of the second portion.

17. The electronic device of claim 1, wherein a second minimum distance is included between the first end and the second end, and the second minimum distance is greater than or equal to 0.5 micrometers.

18. The electronic device of claim 17, wherein the second minimum distance is less than or equal to 0.2 millimeters.

19. The electronic device of claim 1, wherein in the top view of the electronic device, the second end and the metal line are isolated from each other.

20. The electronic device of claim 1, wherein the first end has a first width, the first opening has a second width, and a ratio of the first width to the second width ranges from 0.5 to 2.
